(19) United States
(12) Patent Application Publication
(10) Pub. No.: US 2009/0095266 A1
(43) Pub. Date: Apr. 16, 2009

(54) OZONATION APPARATUS

(75) Inventor: Oleksandr Burmenko, Rockwood (CA)

Correspondence Address: BERESKIN AND PARR, 40 KING STREET WEST, BOX 401, TORONTO, ON, M5H 3Y2, CA

(73) Assignee: Oburtech Motor Corporation, Toronto (CA)

(21) Appl. No.: 11/869,924

(22) Filed: Oct. 10, 2007

(51) Int. Cl. F02M 27/04

(52) U.S. Cl. 123/537

(57) ABSTRACT

An ozonation apparatus is disclosed. The ozonation apparatus is installable upstream of an air intake of at least one cylinder of an internal combustion engine. The ozonation apparatus comprises a casing having an intake port and an exhaust port and a cavity extending therebetween and defining a direction of flow; a plurality of elongate positive electrodes positioned in the cavity, the plurality of elongate positive electrodes being connectable to a voltage source; and a plurality of elongate negative electrodes interspersed among the positive electrodes and spaced therefrom.

### FIELD OF THE INVENTION

The invention relates to an ozonation apparatus or ozonator. More specifically, the invention relates to an ozonation apparatus for use with an internal combustion engine.

### BACKGROUND OF THE INVENTION

An ozonation apparatus used in conjunction with an internal combustion engine improves the fuel economy of the engine by enhancing combustion efficiency. An ozonation apparatus is generally located upstream of the air intake of the cylinders of the engine. Typically, an ozonation apparatus includes a casing through which air flows. The casing houses a positive electrode and a negative electrode. When a voltage is applied to the high voltage electrode, a potential difference is produced between the electrodes and some of the oxygen (O₂) in an air flow passing between the electrodes is ionized, and recombines to form ozone (O₃). Thus, as air passes through the ozonation apparatus, it becomes enriched with ozone before entering the cylinders of the engine.

U.S. Pat. No. 6,769,420 to Motouchi discloses an ozonation apparatus for a combustion engine. The apparatus has a casing, a positive electrode and a negative electrode disposed therein. The positive electrode is plate-like, and the negative electrode is rounded and plate-like. The electrodes are suspended within the casing, and the plates face each other. Power is supplied to the ozonation apparatus via a generator, causing oxygen passing through the casing and between the electrodes to become enriched in ozone.

U.S. Pat. No. 4,519,357 to McAllister discloses another ozonation apparatus. The apparatus has a casing, and a plurality of ionizer units disposed therein. The ionizer units are suspended in the casing such that the longitudinal axis of the ionizer unit is parallel to the flow of air. Each ionizer unit comprises a glass tube having a single inner electrode inside the tube at one end of the tube, and a single outer electrode exterior to the tube around the middle of the tube.

### SUMMARY OF THE INVENTION

In one broad aspect, an ozonation apparatus installable upstream of an air intake of the cylinders of an internal combustion engine is provided. The ozonation apparatus comprises a casing having an intake port and an exhaust port and a cavity extending therebetween. The cavity defines a direction of flow. A plurality of elongate positive electrodes are positioned in the cavity, and are connectable to a voltage source. A plurality of elongate negative electrodes are interspersed among the positive electrodes and spaced therefrom.

An advantage of this broad aspect is that the interspersion of the electrodes may result in the production of a large amount of ozone without unduly restricting the flow of air through the casing and into the cylinders.

In accordance with this aspect of the present invention, there is provided an ozonation apparatus installable upstream of an air intake of an internal combustion engine, the ozonation apparatus comprising:
a casing having an intake port and an exhaust port and a cavity extending therebetween and defining a direction of flow;
a plurality of elongate positive electrodes positioned in the cavity, the plurality of elongate positive electrodes being connectable to a voltage source; and,
a plurality of elongate negative electrodes interspersed among the positive electrodes and spaced therefrom.

In some embodiments, at least some of the elongate positive electrodes and at least some of the elongate negative electrodes extend across at least a majority of a distance of the cavity. In further embodiments, at least some of the elongate positive electrodes and at least some of the elongate negative electrodes extend in a direction transverse to the direction of flow. This may be advantageous because a large surface area of the electrodes will contact the air, resulting in the production of large amounts of ozone.

In some embodiments, at least some of the elongate positive electrodes are substantially parallel with at least some of the elongate negative electrodes.

In some embodiments, at least some of the elongate positive electrodes and at least some of the elongate negative electrodes overlap within the cavity.

In some embodiments, the casing has first and second opposed sides and at least some of the elongate positive electrodes extend inwardly into the cavity from the first opposed side of the casing and at least some of the elongate negative electrodes extend inwardly into the cavity from the second opposed side of the casing. In further embodiments, at least some of the elongate positive electrodes are substantially parallel to at least some of the elongate negative electrodes.

In some embodiments, the elongate positive electrodes and the elongate negative electrodes are each arranged in a 2-dimensional array.

In some embodiments, at least some of the positive electrodes are part of a first assembly and are concurrently received in the cavity and the at least some of the negative electrodes are part of a second assembly and are concurrently received in the cavity. In further embodiments, the first assembly comprises a first plate from which from which at least some of the elongate positive electrodes extend, and the second assembly comprises a second plate from which at least some of the elongate negative electrodes extend, the first plate is positioned adjacent a first side of the casing, and the second plate adjacent a second opposed side of the casing. These embodiments may allow for easy assembly, installation and repair of the ozonation apparatus.

In some embodiments the casing comprises openings positioned to slideably receive electrodes, at least one of the plates is positioned adjacent an outer surface of the casing and the electrodes provided on the plate extend into the cavity through the openings.

In some embodiments, the casing comprises openings positioned to slideably receive electrodes, each of the first and second sides has an outer surface, the first plate is positioned adjacent the outer surface of the first side and the electrodes provided on the first plate extend into the cavity through the openings and the second plate is positioned adjacent the outer surface of the second side and the electrodes provided on the second plate extend into the cavity through the openings.

In some embodiments, the electrodes are removably received in the openings.

In some embodiments, at least some of the elongate positive electrodes and at least some of the elongate negative electrodes are rod-like.

In another broad aspect, an ozonation apparatus installable upstream of an air intake of the cylinders of an internal combustion engine is provided. The ozonation apparatus comprises a casing having an intake port and an exhaust port and a cavity extending therebetween. The cavity defines a direction of flow. A plurality of elongate positive electrodes are positioned in the cavity, and are connectable to a voltage source. A plurality of elongate negative electrodes are positioned in the cavity and extend into spaces between the positive electrodes.

In accordance with this aspect of the present invention, there is provided an ozonation apparatus installable upstream of an air intake of an internal combustion engine, the ozonation apparatus comprising:
a casing having an intake port and an exhaust port and a cavity extending therebetween and defining a direction of flow;
a plurality of elongate positive electrodes positioned in the cavity, the plurality of elongate positive electrodes being connectable to a voltage source; and,
a plurality of elongate negative electrodes positioned in the cavity and extending into spaces between the positive electrodes.

In another broad aspect, a method of operating an internal combustion engine is provided. The method comprises providing an ozonation apparatus comprising a casing having an intake port and an exhaust port and a cavity extending therebetween. The ozonation apparatus further comprises a plurality of elongate positive electrodes, and a plurality of elongate negative electrodes. The method further comprises positioning the elongate positive electrodes within the cavity, and positioning the elongate negative electrodes within the cavity such that they are interspersed among the positive electrodes and spaced therefrom. The method further comprises providing a high voltage to the elongate positive electrodes, passing air between at least some of the elongate positive electrodes and at least some of the elongate negative electrodes, and passing the air into at least one cylinder of an internal combustion engine.

In accordance with this aspect of the present invention, there is provided a method of operating an internal combustion engine comprising:
providing an ozonation apparatus comprising a casing having an intake port and an exhaust port and a cavity extending therebetween; a plurality of elongate positive electrodes; and a plurality of elongate negative electrodes;
positioning the elongate positive electrodes within the cavity;
positioning the elongate negative electrodes within the cavity interspersed among the positive electrodes and spaced therefrom;
providing a high voltage to the elongate positive electrodes;
passing air between at least some of the elongate positive electrodes and at least some of the elongate negative electrodes; and,
passing the air into at least one cylinder of an internal combustion engine.

In some embodiments, the high voltage is supplied from a high voltage power source, and the high voltage power source is powered by the internal combustion engine.

In some embodiments, the method further comprises passing the air between the electrodes in a direction transverse to the electrodes.

In some embodiments, the elongate positive electrodes extend from a first plate, and the elongate negative electrodes extend from a second plate, and the steps of positioning the elongate positive electrodes within the cavity and positioning the elongate negative electrodes within the cavity comprise: positioning the first plate adjacent a first side of the casing; and positioning the second plate adjacent a second side of the casing.

In some embodiments, the first plate and the second plate are positioned exterior to the casing, and the method further comprises: inserting the elongate positive electrodes through openings in the casing into the cavity; and inserting the elongate negative electrodes through openings in the casing into the cavity.

### BRIEF DESCRIPTION OF THE DRAWINGS

These and other advantages of the present invention will be more fully and particularly understood in connection with the following description of the preferred embodiments of the invention in which:

FIG. 1 is a vertical section view of an embodiment of an ozonation apparatus of the present invention;

FIGS. 2A and 2B are perspective views of alternate embodiments of casings of the present invention with the electrodes removed;

FIG. 3A is a horizontal cross section of the ozonation apparatus of FIG. 1, taken along line 3A-3A in FIG. 1;

FIG. 3B is a horizontal cross section of the ozonation apparatus of FIG. 1, taken along line 3B-3B in FIG. 1;

FIG. 4 is a vertical section view of an alternate embodiment of an ozonation apparatus of the present invention; and,

FIG. 5 is an exploded perspective view of the ozonation apparatus of FIG. 1.

### DETAILED DESCRIPTION OF THE INVENTION

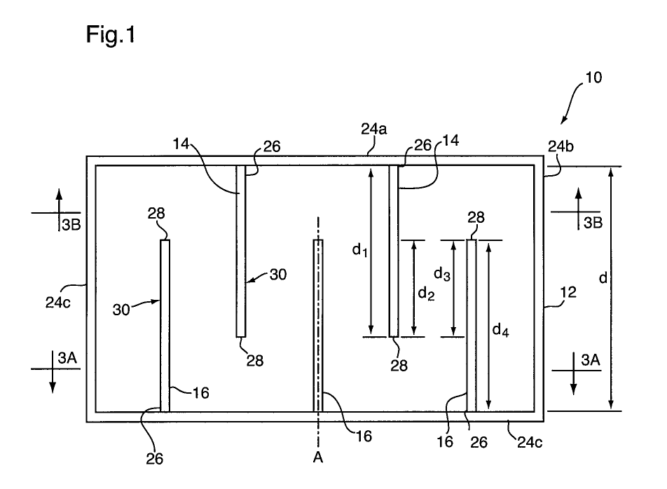

Referring to FIG. 1, an embodiment of an ozonation apparatus 10 of the present invention is shown. Ozonation apparatus 10 comprises a casing 12, a plurality of elongate positive electrodes 14, and a plurality of elongate negative electrodes 16.

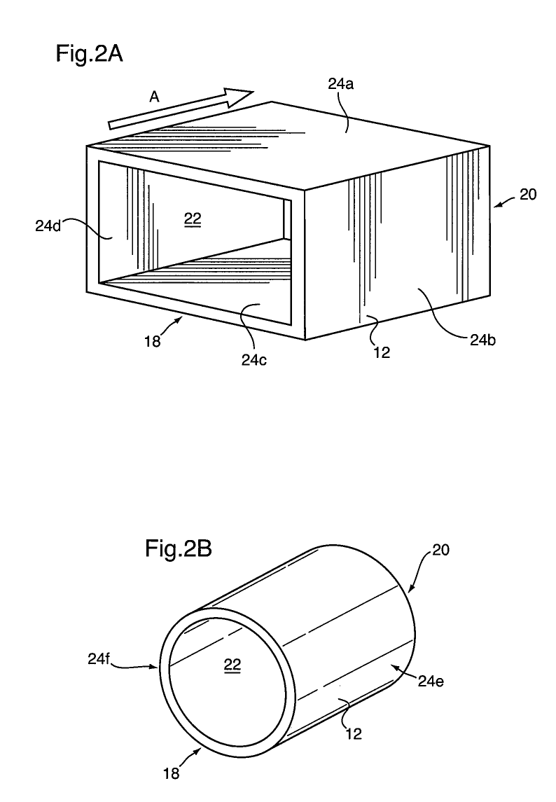

Referring to FIGS. 2A-2B, casing 12 comprises an intake port 18, an exhaust port 20, and a cavity 22. In use, air enters intake port 18, passes through cavity 22, and exits at exhaust port 20. As such, cavity 22 defines a direction of flow, denoted by arrow A.

In the embodiment of FIG. 2A, casing 12 has rectangular transverse cross-section. In such an embodiment casing 12 comprises four sides 24a, 24b, 24c, and 24d. Sides 24a and 24c are on opposing portions of casing 12, and sides 24b and 24d are on opposing portions of casing 12. As such, sides 24a and 24c may be referred to as opposed sides, and sides 24b and 24d may be referred to as opposed sides.

In other embodiments casing 12 may have a substantially round transverse cross-section, as shown in FIG. 2B. In such an embodiment, casing 12 may be substantially tubular. In embodiments wherein casing 12 is tubular, casing 12 may comprise opposed hemispheres 24e and 24f, which may also be referred to as opposed sides 24e and 24f.

In other embodiments, casing 12 may be of another shape, and any two sides or regions which are on opposite portions of the casing may be referred to as opposed sides.

As exemplified, intake port 18 and exhaust port 20 are spaced apart and opposed. Further, as exemplified, intake port 18 and exhaust port 20 each have the same cross sectional area as cavity 22 and accordingly each of intake port 18 and exhaust port 20 may comprise an end face of casing 12. It will be appreciated that cavity 22 may have end faces with intake port 18 and exhaust port 20 having a reduced cross sectional area then cavity 22. In such embodiments, casing 12 may comprise one more end walls in which intake port 18 and/or exhaust port 20 is defined. However it is preferred that intake port 18 and exhaust port 20 are the same cross sectional area, or greater, so as not to create back pressure across the ozonation apparatus 10. It will be appreciated that any intake port and outlet port known in the art may be used.

In the preferred embodiment, casing 12 is fabricated from an electrically insulative material, for example a plastic such as polypropylene. In alternate embodiments, casing 12 may be fabricated from another material used in ozonation apparatus, for example a metal that may be coated with an electrically insulative material.

In any such construction for casing 12, a plurality of positive electrodes 14 and a plurality of negative electrodes 16 are positioned in cavity 22. The negative electrodes 16 are interspersed among the positive electrodes 14 and spaced therefrom. As exemplified in FIG. 1, the negative electrodes 16 extend into spaces between at least two of the positive electrodes 14. In the preferred embodiment, all of the negative electrodes 16 extend into spaces between the positive electrodes 14. In alternate embodiments, it will be appreciated that only some of the negative electrodes 16 extend into spaces between only some of the positive electrodes 14. For example, one or more additional positive electrode and one or more negative electrode need not be elongate and/or need not be interspersed between oppositely charged electrodes but may be of any conventional positioning and configuration.

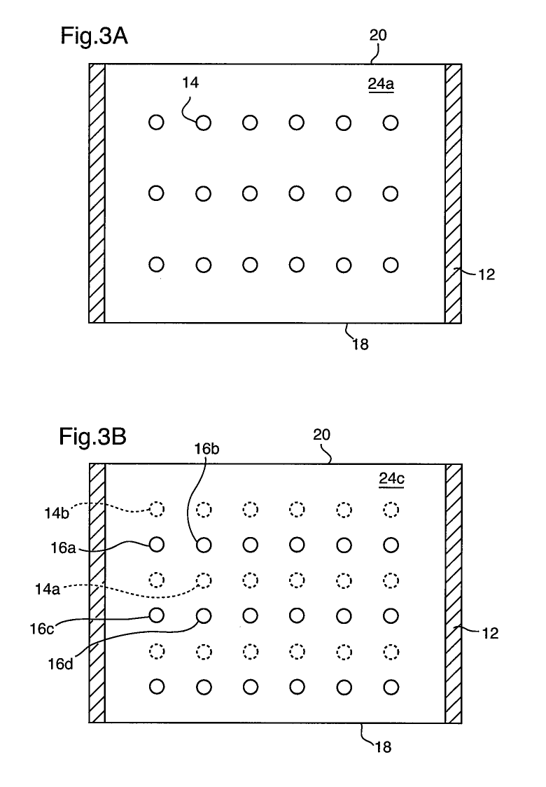

In a preferred embodiment, the positive electrodes 14 and the negative electrodes 16 are each arranged in a 2-dimensional array. For example, the positive electrodes 14 may be arranged in a series of rows and columns as shown in FIG. 3A, and the negative electrodes 16 may be arranged in a series of rows and columns, as shown in FIG. 3B. As exemplified, the positive electrodes 14 are arranged in six rows and three columns on one side of the casing 12, and the negative electrodes are arranged in six rows and three columns on an opposing side of the casing. In alternate embodiments, each array may comprise a different number of electrodes.

In FIG. 3B, the position of positive electrodes 14 are shown in dotted outline. Accordingly, it can be seen that positive electrode 14a is positioned between four negative electrodes 16a, 16b, 16c and 16d. Therefore, positive electrode 14a is interspersed between four negative electrodes 16. It will also be noticed that the outlying electrodes may be adjacent only one oppositely charged electrode. For example, positive electrode 14b is spaced from and closest to negatively charged electrode 16a and is also spaced from negative electrode 16b. Alternate configurations may be used wherein an uneven number of electrodes may be used (e.g., more negative electrodes 16 then positive electrodes 14).

Referring to FIG. 1, the positive electrodes 14 and the negative electrodes 16 are elongate. In particular, using the orthogonal axis X, Y and Z, the electrodes extend further in the Z direction (length) then in the X and Y directions (width and depth). In a preferred embodiment, the positive electrodes 14 and the negative electrodes 16 are rounded elongate members and, more preferably, they are rod-like (e.g., the have a circular transverse section). The transverse section may be generally uniform along the length of the electrode such that the electrodes are substantially cylindrical. It will be appreciated that the electrodes may have an alternate cross section (e.g., square) and still be elongate (in which case they would be rectangular rods). In the preferred embodiment, all of the positive electrodes 14 and all of the negative electrodes 16 are rod-like. In alternate embodiments, only some of the positive electrodes and/or some of the negative electrodes are rod-like.

The positive electrodes 14 and the negative electrodes 16 may be fabricated from any suitable electrically conductive material known in the art, or any suitable combination of materials known in the art. For example, one or more of the positive electrodes 14 and or the negative electrodes 16 may be fabricated from copper.

The distance across the cavity 22 that the positive electrodes 14 and the negative electrodes 16 extend may vary. In the preferred embodiment, at least some, and preferable all, of the positive electrodes 14 and at least some, and preferably all, of the negative electrodes 16 extend across at least a majority of the distance across the cavity. That is, referring to FIG. 1, if the distance across the cavity 22 is d, then the length of at least some of the positive electrodes 14 and at least some of the negative electrodes 16 is greater than or equal to ½ d.

In alternate embodiments, at least some of the positive electrodes 14 may extend across at least a majority of the distance across the cavity, and at least some of the negative electrodes 16 may extend less than a majority of the distance across the cavity, such that the combined length of the positive electrodes and the negative electrodes is greater than the distance across the cavity. Alternately, at least some of the negative electrodes 16 may extend across at least a majority of the distance across the cavity, and at least some of the positive electrodes 14 may extend less than a majority of the distance across the cavity, such that the combined length of the negative electrodes and the positive electrodes is greater than the distance across the cavity. For example, the length of at least some of the positive electrodes 14 may be ¾ d, and the length of at least some of the negative electrodes 16 may be ⅓ d.

In yet other embodiments, e.g., the positive electrodes 14 may positioned in the middle of cavity 22 and do not extend inwardly from a wall 24. Accordingly, all of the positive electrodes may have a length of ¼ d. If the positive electrodes 14 and the negative electrodes 14 are positioned in the middle of cavity 22 and do not extend inwardly from a wall 24, then all of the positive electrodes 14 and all of the negative electrodes 16 may extend across less than a majority of the distance across the cavity. For example, all of the positive electrodes may have a length of ¼ d, and all of the negative electrodes may have a length of ¼ d. It will be appreciated if all of the electrodes extend inwardly from the same wall, then again positive electrodes 14 and negative electrodes 16 may extend across less than a majority of the distance across the cavity 22.

In these configurations, it will be appreciated that at least one of the positive electrodes 14 and at least one of the negative electrodes 16 may overlap within the cavity 18. For example, referring to FIG. 1, positive electrode 14 has a length d1 from proximal end 26 adjacent the inner surface or wall 24a to distal end 28 and negative electrode 16 has a length d4 from proximal end 26 adjacent the inner surface or wall 24c to distal end 28. The portion of positive electrode 14 extending outwardly from distal end 28 towards wall 24a, which has a length d2, is spaced from and extends through the same portion of cavity 22 as the portion of negative electrode 16 extending outwardly from distal end 28 towards wall 24c, which has a length d3. If distance d extends vertically, then distal end 28 of positive electrode 14 is lower then distal end 28 of negative electrode 16. Lengths d2 and d3 are the same and define the overlap, i.e., the portion of the electrodes that extends through the same portion of cavity 22.

The positive electrodes 14 and the negative electrodes 16 may be arranged in a variety of configurations in cavity 22. In the embodiments shown, all of the positive electrodes 14 and all of the negative electrodes 16 extend inwardly from opposed walls 24 of the casing 12 into the cavity 22. That is, at least a portion of each electrode contacts or is adjacent an inner surface of a wall 24 of the casing 12. In alternate embodiments, some or all of the positive electrodes 14 and/or negative electrodes 16 may not extend inwardly from the casing 12 but may be mounted internally in cavity 22.

In the preferred embodiment, at least some, and preferably all, of the positive electrodes 14 extend from one side of the casing 12, and at least some, and preferably all, of the negative electrodes 16 extend from an opposed side of the casing 12. More preferably, the electrodes extend substantially across cavity 22. For example, as shown in FIG. 1, the positive electrodes 14 extend from side 24a, and the negative electrodes 16 extend from side 24c. In alternate embodiments the positive electrodes 14 and the negative electrodes 16 may extend from adjacent sides of the casing, for example from sides 24a and 24b. In a further alternate embodiment the positive electrodes 14 and the negative electrodes 16 may extend from the same side of the casing, for example from sides 24a. In further alternate embodiments, the positive electrodes 14 may extend from more than one side of the casing, and the negative electrodes 16 may extend from more than one side of the casing 12.

The positive electrodes 14 and the negative electrodes 16 may extend from a wall 24 at a variety of angles. Furthermore, the positive electrodes 14 and the negative electrode 16 may be at a variety of angles with respect to the direction of flow (A) defined by the casing 12.

In a preferred embodiment, at least some, and preferably all, of the positive electrodes 14 and at least some, and preferably all, of the negative electrodes 16 extend in a direction that is substantially perpendicular to the wall 24 from which they extend. If the walls are opposed, then in such embodiments, the positive electrodes 14 may be substantially parallel to the negative electrodes 16. In alternate embodiments, one or more of the positive electrodes 14 and/or one or more of the negative electrodes 16 may extend from the casing at a different angle.

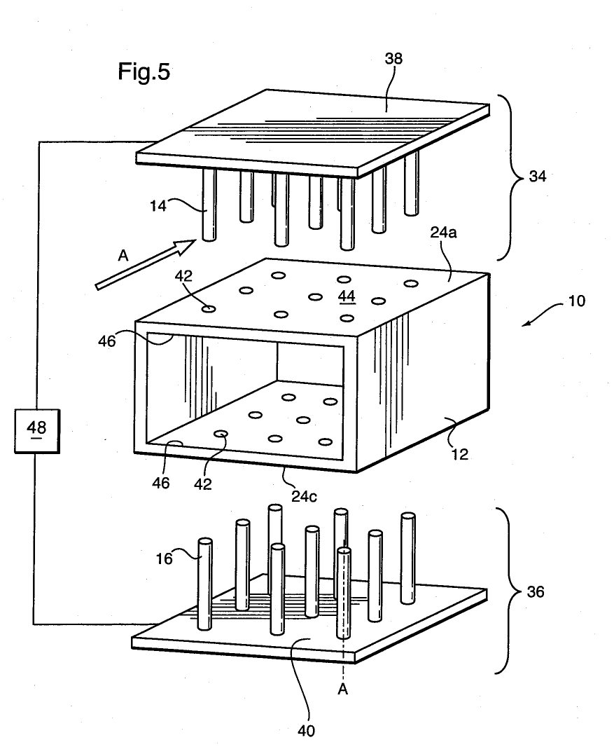

In a preferred embodiment, at least some, and preferably all, of the positive electrodes 14 and at least some, and preferably all, of the negative electrodes 16 extend in a direction that is substantially transverse to the direction of flow (A). As exemplified in FIGS. 1 and 5, positive electrodes 14 and negative electrodes 16 extend inwardly from opposed walls that define cavity 22 and therefore have a longitudinal axis A that is transverse to the direction of flow (A).

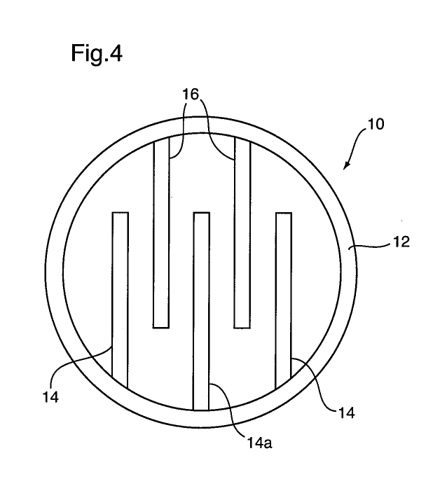

In another preferred embodiment, as shown in FIG. 4, casing 12 is tubular, and only one of the electrodes 14a extends perpendicularly from the casing. The remainder of the electrodes are parallel to the one perpendicular electrode 14a. In this embodiment, at least some, and preferably all of the electrodes may extend in a direction that is transverse to the direction of flow (A).

It will be appreciated that, in any particular embodiment, all or some of positive electrodes 14 may be parallel to each other, all or some of negative electrodes 16 may be parallel to each other, all or some of positive electrodes 14 and negative electrodes 16 may extend inwardly from the same or a different wall 24 and/or they may be mounted internally within cavity 22 and all or some of positive electrodes 14 and negative electrodes 16 may extend generally transverse to the direction of flow (A). Preferably, in any embodiment, all or some of positive electrodes 14 and negative electrodes 16 extend substantially across cavity 22 or essentially all of the way across cavity 22.

In any of these embodiments, the positive electrodes 14 and the negative electrodes 16 may be permanently fixed in or to the casing 12 or may be removably mounted thereto. For example, the proximal ends 26 of the electrodes may be adhered or permanently affixed to the casing 12. In the preferred embodiment, the positive electrodes 14 and the negative electrodes 16 are removably received in or to the casing 12. This may be achieved in a variety of ways.

In some embodiments, each electrode may be individually removable from the casing 12. For example, the casing 12 may comprise a plurality of threaded members onto which each electrode may be screwed.

In the preferred embodiment, at least some and preferably all of the positive electrodes 14 may be concurrently removable from the casing 12, and/or at least some and preferably all of the negative electrodes 16 may be concurrently removable from the casing 12. For example, as shown in FIG. 5, the positive electrodes 14 may be part of a first assembly 34, and the negative electrodes 16 may be part of a second assembly 36. The first assembly 34 may include the positive electrodes 14 and a first plate 38 from which they extend, and the second assembly 36 may include the negative electrodes 16 and a second plate 40 from which they extend. The first assembly 34 allows for the all of the positive electrodes 14 to be concurrently removable from the casing and the second assembly 36 allows for the all of the negative electrodes 16 to be concurrently removable from the casing.

In a preferred embodiment, electrodes are removable from the casing via openings 42. That is, the casing 12 comprises openings 42 positioned to receive the electrodes. In such an embodiment, the positive electrodes 14 and the negative electrodes may be slid through the openings 42 into the casing 12, until the first plate 38 is adjacent outer surface 44 of wall 24a of the casing 12, and the second plate 40 is adjacent an outer surface 44 of wall 24c of the casing 12. The first plate 38 and/or the second plate 40 may optionally be secured to the casing 12, for example by screws, an adhesive, mating engagement members or any other means known in the art. An airtight seal may be created by any means known in the art, such as an O-ring.

Accordingly, in a preferred embodiment, plate 38 is aligned with casing 12 such that openings 42 are aligned with electrodes 14. Electrodes 14 may then be concurrently inserted into cavity 22. It will be appreciated that an opening 42 may be sized to receive a single electrode or may be sized to receive a plurality of electrodes. Further, wall 24 that receives a plate 38, 40 may have an opening sized to receive all of the electrodes on the plate 38, 40.

Alternately, electrodes 14 and/or 16 may be mounted within cavity 22. For example one or both of plates 38, 40 may be mounted to an inner surface 46 of walls 24. For example, the electrodes may be removable from the casing via rails provided in cavity 22 (not shown). In such an embodiment, the first plate 38 and the second plate 40 may be slideable into the casing along the rails. Alternately one or both of plates 38, 40 may be secured to an inner surface 46 of walls 24, for example by screws, an adhesive, mating engagement members or any other means known in the art.

The first plate 38 and the second plate 40 may be fabricated from a variety of materials. For example, the first plate 38 and/or the second plate 40 may be fabricated from an electrically conductive material. In such embodiments, the first plate 38 and/or the second plate 40 may be fully or partially coated with an electrically insulative material. In another example, the first plate 38 and/or the second plate 40 may be fabricated from an electrically insulative material.

The positive electrodes 14 and the negative electrodes 16 are connectable to a voltage source 48 as is known in the art. The voltage source may be, for example, a battery, a generator, or any other suitable voltage source known in the art. In the preferred embodiment, the ozonation apparatus 10 is installed upstream of an air intake of at least one cylinder of an internal combustion engine. In such an embodiment, the internal combustion engine powers an alternator, and the alternator may be the voltage source 48 for the ozonation apparatus 10. In such an embodiment, the alternator may be either directly coupled to the ozonation apparatus 10, or may be indirectly coupled to the ozonation apparatus. In embodiments wherein the alternator is indirectly coupled to the ozonation apparatus 10, there may be a voltage regulator positioned between the alternator and the ozonation apparatus 10.

In some embodiments, the positive electrodes 14 and the negative electrodes 16 are permanently connected to the voltage source 48. In the preferred embodiment, the positive electrodes 14 and the negative electrodes 16 are removably connected to the voltage source 48.

In the preferred embodiment, in which the positive electrodes 14 extend from a first plate 38, and the negative electrodes 16 extend from a second plate 40, the positive electrodes 14 may be connectable to the voltage source 48 via the first plate 38 and the negative electrodes 16 may be connectable to the voltage source via the second plate 40. In alternate embodiments, each of the electrodes may be individually connectable to the voltage source.

In use, ozonation apparatus 10 may be installed upstream of the air intake of at least one cylinder, and preferably each cylinder, of an internal combustion engine. For example, ozonation apparatus 10 may be installed in an automobile.

Ozonation apparatus 10 may be provided in an assembled state, with the electrodes already positioned in the cavity, or may be provided in an unassembled state. If the ozonation apparatus 10 is in an unassembled state, the user may assemble the ozonation apparatus by positioning the positive electrodes 14 within the cavity 22, and positioning the negative electrodes 16 within the cavity 22, such that they are interspersed among the positive electrodes 16 and spaced therefrom. In some embodiments, the electrodes are positioned in the cavity by positioning first plate 38 adjacent a first side of the casing 12, and by positioning a second plate 40 adjacent a second side of the casing 12. In the preferred embodiment, the first plate and the second plate are positioned exterior to the casing 12, and the electrodes are slid into the cavity 22 via openings in the casing.

Ozonation apparatus 10 may be assembled prior to installation or after installation. That is, ozonation apparatus 10 may be assembled, and then installed, or the casing 12 may be installed, and then the electrodes may be positioned in the casing.

When the ozonation apparatus 10 has been assembled and installed, the electrodes may be connected to a voltage source 48. The electrodes may be connected to the voltage source by any means known in the art, and are preferably connected via first 38 and second 40 plates.

Air may then enter the intake port 18 of the cavity 22, and pass through the casing 12, such that the air passes between at least some of the positive electrodes 14 and at least some of the negative electrodes 16. In the preferred embodiment, the air travels in a direction that is at least generally transverse to the longitudinal axis A of the electrodes. That is, the direction of airflow is preferably at least generally perpendicular to the longitudinal axes of the electrodes. As the air passes between the electrodes, some of the oxygen in the air is converted to ozone.

It will be appreciated that certain features of the invention, which are, for clarity, described in the context of separate embodiments or separate aspects, may also be provided in combination in a single embodiment. Conversely, various features of the invention, which are, for brevity, described in the context of a single embodiment or aspect, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present invention.

We claim:

1. An ozonation apparatus installable upstream of an air intake of at least one cylinder of an internal combustion engine, the ozonation apparatus comprising:
a casing having an intake port and an exhaust port and a cavity extending therebetween and defining a direction of flow;
a plurality of elongate positive electrodes positioned in the cavity, the plurality of elongate positive electrodes being connectable to a voltage source; and,
a plurality of elongate negative electrodes interspersed among the positive electrodes and spaced therefrom.

2. The ozonation apparatus of claim 1, wherein at least some of the elongate positive electrodes and at least some of the elongate negative electrodes extend across at least a majority of a distance of the cavity.

3. The ozonation apparatus of claim 2, wherein the at least some of the elongate positive electrodes and at least some of the elongate negative electrodes extend in a direction transverse to the direction of flow.

4. The ozonation apparatus of claim 1, wherein at least some of the elongate positive electrodes are substantially parallel with at least some of the elongate negative electrodes.

5. The ozonation apparatus of claim 1, wherein at least some of the elongate positive electrodes and at least some of the elongate negative electrodes overlap within the cavity.

6. The ozonation apparatus of claim 1, wherein the casing has first and second opposed sides and at least some of the elongate positive electrodes extend inwardly into the cavity from the first opposed side of the casing and at least some of the elongate negative electrodes extend inwardly into the cavity from the second opposed side of the casing.

7. The ozonation apparatus of claim 6, wherein at least some of the elongate positive electrodes are substantially parallel to at least some of the elongate negative electrodes.

8. The ozonation apparatus of claim 1, wherein the elongate positive electrodes and the elongate negative electrodes are each arranged in a 2-dimensional array.

9. The ozonation apparatus of claim 1, wherein at least some of the positive electrodes are part of a first assembly and are concurrently received in the cavity and the at least some of the negative electrodes are part of a second assembly and are concurrently received in the cavity.

10. The ozonation apparatus of claim 9, wherein the first assembly comprises a first plate from which from which at least some of the elongate positive electrodes extend, and the second assembly comprises a second plate from which at least some of the elongate negative electrodes extend, and wherein the first plate is positioned adjacent a first side of the casing, and the second plate adjacent a second opposed side of the casing.

11. The ozonation apparatus of claim 10, wherein the casing comprises openings positioned to slideably receive electrodes, at least one of the plates is positioned adjacent an outer surface of the casing, and the electrodes provided on the plate extend into the cavity through the openings.

12. The ozonation apparatus of claim 10, wherein the casing comprises openings positioned to slideably receive electrodes, each of the first and second sides has an outer surface, the first plate is positioned adjacent the outer surface of the first side and the electrodes provided on the first plate extend into the cavity through the openings and the second plate is positioned adjacent the outer surface of the second side and the electrodes provided on the second plate extend into the cavity through the openings.

13. The ozonation apparatus of claim 12, wherein the electrodes are removably received in the openings.

14. The ozonation apparatus of claim 1, wherein at least some of the elongate positive electrodes and at least some of the elongate negative electrodes are rod-like.

15. An ozonation apparatus installable upstream of an air intake of at least one cylinder an internal combustion engine, the ozonation apparatus comprising:
a casing having an intake port and an exhaust port and a cavity extending therebetween and defining a direction of flow;
a plurality of elongate positive electrodes positioned in the cavity, the plurality of elongate positive electrodes being connectable to a voltage source; and
a plurality of elongate negative electrodes positioned in the cavity and extending into spaces between the positive electrodes.

16. A method of operating an internal combustion engine comprising:
providing an ozonation apparatus comprising a casing having an intake port and an exhaust port and a cavity extending therebetween; a plurality of elongate positive electrodes; and a plurality of elongate negative electrodes;
positioning the elongate positive electrodes within the cavity;
positioning the elongate negative electrodes within the cavity interspersed among the positive electrodes and spaced therefrom;
providing a high voltage to the elongate positive electrodes;
passing air between at least some of the elongate positive electrodes and at least some of the elongate negative electrodes; and,
passing the air into at least one cylinder of an internal combustion engine.

17. The method of claim 16, wherein the high voltage is supplied from a high voltage power source, and the high voltage power source is powered by the internal combustion engine.

18. The method of claim 16, further comprising passing the air between the electrodes in a direction transverse to the electrodes.

19. The method of claim 16, wherein the elongate positive electrodes extend from a first plate, and the elongate negative electrodes extend from a second plate, and the steps of positioning the elongate positive electrodes within the cavity and positioning the elongate negative electrodes within the cavity comprise:
positioning the first plate adjacent a first side of the casing; and
positioning the second plate adjacent a second side of the casing.

20. The method of claim 19, wherein the first plate and the second plate are positioned exterior to the casing, and the method further comprises:
inserting the elongate positive electrodes through openings in the casing into the cavity; and
inserting the elongate negative electrodes through openings in the casing into the cavity.
